(19) United States
(12) Patent Application Publication
(10) Pub. No.: US 2015/0128067 A1
(43) Pub. Date: May 7, 2015

(54) SYSTEM AND METHOD FOR WIRELESSLY SHARING DATA AMONGST USER DEVICES

(71) Applicants: Alison Han-Chi Wong, Menlo Park, CA (US); Itai Vonshak, San Jose, CA (US); Eric Liu, Redwood City, CA (US); Stefan Marti, Oakland, CA (US); Seung Wook Kim, Cupertino, CA (US)

(72) Inventors: Alison Han-Chi Wong, Menlo Park, CA (US); Itai Vonshak, San Jose, CA (US); Eric Liu, Redwood City, CA (US); Stefan Marti, Oakland, CA (US); Seung Wook Kim, Cupertino, CA (US)

(21) Appl. No.: 14/356,867

(22) PCT Filed: Nov. 16, 2011
(86) PCT No.: PCT/US2011/061027

§ 371 Date: Dec. 18, 2014

(51) Int. Cl. H04L 29/08; G06F 3/0488

(52) U.S. Cl. CPC H04L 67/32; G06F 3/0488
USPC 715/748; 709/217

(57) ABSTRACT

A system and method for sharing data between devices are provided. A source device detects one or more receiving devices that are operated in a mode to receive data from the source device. The source device detects a user action that signifies intent of a user to transmit data to the one or more receiving devices. In response to detecting the user action, the source device identifies data that is in a state designated to be transmitted. The identified content is transmitted to the one or more receiving devices.

### TECHNICAL FIELD

The disclosed embodiments relate to a system and method for wirelessly sharing data amongst user devices.

### BACKGROUND

Consumer electronic devices often use wireless communications to share data. Such devices use a variety of wireless communication protocols, such as BLUETOOTH and Wireless Fidelity WIFI (e.g., 802.11(e) or (g)) to communicate with one another.

### BRIEF DESCRIPTION OF THE DRAWINGS

FIG. 1 illustrates a system for wirelessly sharing data amongst devices in response to a user action, according to an embodiment.

FIG. 2 illustrates a method for wirelessly sharing data amongst devices in response to a user action, according to an embodiment.

FIG. 3 illustrates a method for wirelessly sharing data with another device in response to a user action, under another embodiment.

FIGS. 4A-4D illustrate a plurality of user interface features on a computing device for sharing data amongst devices, according to an embodiment.

FIGS. 5A-5D illustrate a plurality of user interface features on a receiving device for receiving data from a source device, according to one or more embodiments.

FIGS. 6A-6E illustrate a usage scenario for sharing data amongst a plurality of devices, under an embodiment.

FIGS. 7A-7D illustrate a usage scenario for sharing data amongst a plurality of devices, under another embodiment.

FIG. 8 illustrates a hardware diagram of a computing device for wirelessly sharing data amongst devices in response to a user action, according to one or more embodiments.

### DETAILED DESCRIPTION

Embodiments described herein include a system and method for enabling a user to seamlessly share data from his or her computing device to other devices that are within a vicinity or proximity of the user. A user can perform an action to indicate his or her intent to share data. The computing device interprets the user action (that is performed on the computing device) as signifying the user's intent to share data and performs a sequence of steps to transmit the data (e.g., files, links, metadata, pointers) to other devices. In response to detecting the user action, the computing device may promptly share data with a number of devices that are in a mode to receive data from the user's computing device. Embodiments provide an intuitive system and method for sharing data with devices that are in a close vicinity or proximity to a computing device.

According to an embodiment, the source device detects one or more receiving devices (e.g., devices that are to receive shared data). The one or more receiving devices are configured to operate in a mode to receive data from the source device. In some embodiments, users of the one or more receiving devices (e.g., receiving users) can perform some action on their receiving device (before, during, or after the detection) in order to place the receiving device in a mode to able to receive data from the source device.

In another embodiment, the source device can present on its display one or more graphic features indicating each of the detected receiving devices. The source device can include one or more sensors for detecting the position or location of the receiving devices (relative position to the source device or absolute position, or both) and can present the one or more graphic features on the display in a manner corresponding to the position or location of the receiving devices.

In one or more embodiments, a user action is detected by the source device. The user action signifies intent of the user to transmit or share data to the one or more detected receiving devices. The device can detect a variety of different user actions, such as gestures made on a touch screen display of the user's source device, movements of the computing device itself, or a combination of both, and interpret the user action as signifying intent to transmit data. In response to detecting the user action, the source device identifies data that is in a state designated to be transmitted. The identified data can include data corresponding to a document, a message (e.g., SMS, MMS, email), contact information, calendar entries, a content from a website, media files (e.g., images, audio, video), applications, metadata, a link (e.g., URL), or other data that can be accessed by a computing device.

According to an embodiment, the source device transmits the identified data to the one or more receiving devices. In response to detecting the user action, the source devices automatically established a wireless connection between the sharing or computing device and the one or more receiving devices. The identified data is transmitted using the established wireless connection. The wireless connection can use a Bluetooth protocol communication, a Wi-Fi protocol communication, infrared communication or visible light communication in order to transfer data between devices.

In other embodiments, the source device can transmit a pointer to information stored in a network and that corresponds to the identified data. The one or more receiving devices can automatically launch or display content corresponding to the identified data in response to retrieving the information from the network. As an addition or alternative, once the wireless connection is established, the sharing user may share other (or additional) data in response to another user action.

In another embodiment, the source device can share data with one other receiving device by making a determination whether the receiving device is in substantial alignment with the computing device. In order to make the determination, the source device can use one or more of its sensors in order to determine that the user wants to share data with another device. The source device detects a user action that signifies intent of the user to transmit or share data with another device. In response to the detecting the user action, the source device identifies data that is in a state designated to be transmitted. The identified data is transmitted to the receiving device using an automatically established wireless connection between the source device and the receiving device.

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein can be implemented using programmatic modules or components. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computers, including processing and memory resources. For example, one or more embodiments described herein may be implemented, in whole or in part, on computing machines such as desktop computers, cellular phones, personal digital assistants (PDAs), laptop computers, printers, digital picture frames, and tablet devices. Memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

In the context of “substantial alignment”, or variations thereof, two devices are substantially aligned if they are directionally oriented towards one another sufficiently to enable one device to select the other device apart from one or more other devices that are proximate (or equally proximate) to the selected device or substantially equally spaced from the selecting device.

System Description

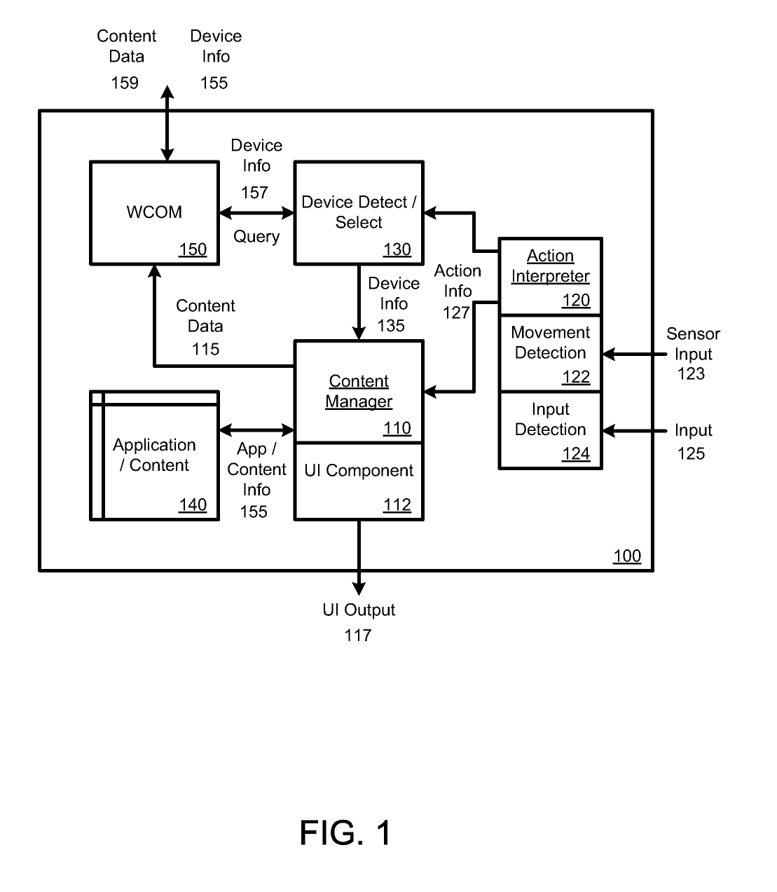

FIG. 1 illustrates a system for wirelessly sharing data amongst devices in response to a user action, according to an embodiment. A system such as described with respect to FIG. 1 can be implemented on, for example, a mobile computing device or small-form factor device, or other computing form factors such as tablets, notebooks, desktops computers and the like. In one embodiment, system 100 enables a user to share data with multiple devices in response to a user action.

According to an embodiment, system 100 includes content manager 110, action interpreter 120, device detect/select component 130, application/content database 140, and a wireless communication component 150. Content manager 110 communicates with action interpreter 120 in order to receive action information 127 from the action interpreter 120 when a user action is performed. In some embodiments, action interpreter 120 includes movement detection 122 and input detection 124. Movement detection 122 receives sensor input 123 that corresponds to movements of the computing device performed by a user. Action interpreter 120 can also include, as an alternative or addition, input detection 124, which receives input 125 corresponding to user input performed by a user on a user input mechanism(s) of the computing device, e.g., an input received via a touch screen display and/or input received through a button press of one or more buttons or keys of the computing device.

In some embodiments, content manager 110 includes a user interface (UI) component 112 that generates user interface features 117 that are output on a display of the computing device. UI component 112 can provide user interface features that enable a user to interact with applications, navigate between applications, and access data and content through user input mechanisms. For example, a user interface feature can be provided on the display that represents a currently running or operating application or that shows content, such as a photograph or a document that the user is currently viewing. In some embodiments, the display of the computing device can be a touch screen display so that the user can interact with the user interface features by making contact with the touch screen display using a finger(s) or hand (e.g., tap on a soft button or icon, drag and hold a graphic feature, etc.).

In one embodiment, content manager 110 communicates with application/content database 140 to receive application and/or content information 155. When a user opens or launches an application, such as a calendar application, for example, content manager 110 retrieves application and/or content information 155 (e.g., data corresponding to content) and UI component 112 generates a user interface feature that corresponds to the calendar application for displaying on the display. The user can also access other applications concurrently, such as a media player or a photo application, in order to playback or view various corresponding content using that particular application while interacting with a currently operating application at the same time. The user can navigate between these applications in order to view and select content he or she wants to share.

Using the user interface features generated by the UI component 112, the user can navigate through different applications and content. For example, if the user wants to view a photograph that is stored in a memory of the computing device using a photo application, content manager 110 can retrieve data 155 that corresponds to the photograph so that the UI component 112 outputs data for the photo 117 for displaying on the display. Data that can be shared or transmitted can include documents, messages (e.g., SMS, MMS, email), contact information, calendar entries, websites (or a website addresses), media files (e.g., images, audio, video), applications, games or games data, metadata, or other data that can be accessed by a computing device.

When a user intends to share content or data with one or more other devices in his or her vicinity, the user may perform or provide a user action or input in order to cause the computing device to detect receiving devices in a predetermined proximity. According to one or more embodiments, a user input is detected by action interpreter 120 and action information 127 is provided to device detect/select component 130. Action interpreter 120 receives various inputs and interprets what action has been performed by a user of the computing device. In some embodiments, movement detection 122 receives information from one or more sensors via sensor input 123 and action interpreter 120 determines what action has been performed. The one or more sensors may be an accelerometer(s), a gravitometer(s) and a magnetometer(s), which can be used individually or in conjunction with each other to determine the speed of the movement of the computing device, the direction of the movement, and/or the orientation of the computing device (e.g., which direction it is facing—north, south, etc., or which orientation it is being held or placed—portrait, landscape, tilted in between).

Action interpreter 120 can also generate action information 127 in response to input detection 124 receiving input 125. Input 125 can correspond to input that is received from a user action on one or more input mechanisms. The input mechanism can be a full alphanumeric keyboard and/or other keys/buttons, and/or can be a touch screen display. Input detection 124 receives input 125 that is performed on the input mechanism and the action interpreter 120 determines the user action and provides action information 127 to content manager 110 and device detect/select component 130. Using information from movement detection 122 and/or input detection 124, action interpreter 120 can determine if a user wants to share content with other devices. Action interpreter 120 can also determine whether a user action signifies intent of the user to transmit content to other devices. Action interpreter 120 can also make this determination using other information of the computing device (e.g., what mode or state the device is in, settings set by the user).

In some embodiments, the user action may include a button press or multiple button presses on keys or buttons, or a tap or multiple taps (using one or multiple fingers or parts of the hand) of a user interface feature or soft button or icon on a touch screen display of the computing device. In other embodiments, the user action may be a tap, drag and release of a user interface feature, or a swiping gesture of a user interface feature. The user action may also be a movement of the computing device itself by the user, e.g., a shake or a frisbee throwing action, or a combination of both a user input on a touch screen display as well as a concurrent movement of the computing device. In some embodiments, for computing devices with a flexible display and/or housing, the user action may be a partial bend or flex of the flexible display as signifying intent to share or transmit content. Other user actions are also possible.

As discussed, in response to receiving a user input (via action interpreter 120 providing action information 127), device detect/select component 130 can send a query to the wireless communication component 150 to retrieve information about devices in the vicinity of the computing device. In some embodiments, the wireless communication component 150 initiates device detection using wireless networking channels such as Bluetooth protocol or Wi-Fi protocol (e.g., in conjunction with a global positioning system), or using various sensors for such as radio-frequency, infrared or ultrasound localization methods to detect nearby (i.e., within a vicinity or predetermined proximity of the computing device) devices. A user input that is interpreted by action interpreter 120 can behave as a trigger to cause the device detect/select component 130 to receive, via the wireless communication component 150, the device information 155 of the detected devices (e.g., receiving devices that are to receive content from the system 100).

For example, when a user is accessing a browser application and wants to share a website he or she is currently viewing on the computing device to other users in his or her vicinity, the user may do so using system 100 in a seamless and efficient manner. The user may perform a user action, such as a tap, hold and drag of the user interface feature corresponding to the browser application that causes device detect/select component 130 to query the wireless communication component 150 and retrieve device information immediately. Using wireless networking channels, system 100 detects one or more devices and the wireless communication component 150 provides device information 155 to device detect/select component 130. The device information 155 corresponds to the devices that have been detected and are in the vicinity of the computing device. This information can be provided to content manager 110.

In some embodiments, only devices that are operated in a mode to receive data from another computing device is detected by the system 100. This way, a user who wants to share data will only see devices that want to receive content, which helps make selection (when sending data to one device at a time, in some embodiments) easier. When a user wants to share data from his or her computing device with other users, the other users (e.g., receiving users) may choose to accept data or prevent data from being received. A receiving user may make his or her devices available to receive data (e.g., operate in a mode to receive content) by performing one or more actions on the receiving device.

For example, a user who wants to receive data on his or her receiving device can signal that his or her device is “visible” or in a mode to receive data using different triggers. According to an embodiment, the trigger can be orientation and/or positioning based. For example, the receiving user may hold the receiving device in an upright position (e.g., so the front face is perpendicular to the ground) or other positions so that the accelerometer(s) and/or gravitometer can be used as a signal to place the receiving device in a mode that is capable of accepting data. In another embodiment, the trigger can be motion based. In this scenario, the receiving user may move the receiving device in a particular manner (e.g., a flick motion or a shake) so that the accelerometer(s) and/or gravitometer can be used to signal that a particular motion has been made. This may place the receiving device in a mode to receive data. Other triggers can include orientation or positioning of the receiving device relative to the source device (described below) or settings that can be manually altered or set by the receiving user (e.g., setting device preferences to always receive data from a user or from a particular user, or at certain times). In other embodiments, the receiving user may set the settings so that a notification is provided to the receiving user whenever a source device attempts to detect devices to send data to, and/or a user may confirm or reject the subsequently sent data.

In some embodiments, once the devices that are in proximity to the computing device or source device are detected via the wireless communication component 150, device detect/select component 130 detects the receiving devices that are operated in a mode to receive data from the computing device. Content manager 110 receives device information 135 about the detected receiving devices that are in a mode to receive data from device detect/select component 130. In one embodiment, UI component 112 can generate a user interface feature that illustrates one or more graphic features that depict or represent the detected receiving devices. In this manner, the user may see a visualization of the detected devices instead of a just a list view of detected devices. For example, UI component 112 can provide a user interface that corresponds to a “radar field” where graphic features of detected devices are provided. In some embodiments, each graphic feature can depict the particular device detected and include some indication that shows the detected receiving device and who the device belongs to (e.g., using different graphic features and/or text). If two receiving devices are detected that are each operated in a mode to receive content, UI component 112 can provide on a portion of the user interface (e.g., on the radar field), two separate graphic images that each represent one of the detected devices.

In other embodiments, device detect/select component 130 can also communicate and/or receive input from one or more sensors of the computing device to receive position information about the receiving devices. Using data from the one or more sensors, device detect/select component 130 can provide relative and/or absolute position information about each of the receiving devices to the computing device. Each of the receiving devices can include location aware resources, such as a global positioning system (GPS) or other navigation or geolocation systems, that provide information about the location of the receiving device. Such information can correspond to general location information, such as city or zip code or address, or correspond to specific latitude and longitude coordinates. This information can be provided to the computing device wirelessly.

In some embodiments, the receiving device and the computing device can communicate with each other using a combination of relative position detectors and sensors. For example, some technologies allow for a position of an object (e.g., such as a receiving device) to be detected at a distance away from the computing device by using ultrasonic triangulation, radio-frequency (RF) triangulation, and infrared (IR) triangulation. In one embodiment, the computing device can use ultrasonic triangulation to determine the position or location of the receiving device. In ultrasonic triangulation, the receiving device includes a speaker that emits an ultrasonic signal to the computing device. The computing device includes three or more microphones (or receptors) that receive the ultrasonic signal from the receiving device, and use the difference in timing and signal strength to determine the object's location and movement.

In another embodiment, the computing device can employ RF triangulation to determine the position or location of the receiving device relative to the computing device. In RF triangulation, the receiving device includes a RF emitter that transmits an RF signal. The computing device includes three or more RF antennas to receive the RF signal from the object, and use the difference in timing, signal strength, and phase to determine the receiving device's location and movement. In other embodiments, IR triangulation can be used by the computing device. In IR triangulation, the receiving device includes an IR emitter that emits and IR signal. The computing device includes three or more IR detectors to receive the IR signal, and use the difference in timing, signal strength, and phase to determine the receiving device's location and movement.

Alternatively, other methods, such as multilateration or trilateration can be used by the computing device to determine position or location information about the receiving device. In one embodiment, a signal emitter can be provided on the computing device and the three or more sensors can be provided on the receiving device. The computing device can then emit a signal (e.g., ultrasound, RF, IR), which is picked up by the three or more sensors on the receiving device. The processing of the information (e.g., trilateration) provided by the sensors can occur at the receiving device or at the computing device. This information is shared between the devices so that the computing device can determine the location of the receiving device relative to the computing device. One advantage of this technique is that multiple receiving devices can be used in parallel (or conjunction) with the computing device. Once the position and/or location of the receiving device is determined by any of the above-described techniques at a particular time, device detect/select component 130 can provide the device information 135 to content manager 110.

By using the position and/or orientation information of the receiving devices, UI component 112 can provide a user interface feature that illustrates one or more graphic features that depict or represent the detected receiving devices in manner corresponding to the actual locations of the receiving devices. For example, if a user wants to share data with three users, Abbey, Bob and Charlie, who are operating devices, A, B and C respectively, and the three users are sitting across from the user in a conference room in the order of B, A, and C from left to right, the UI component 112 can provide a radar field (as discussed above) with three graphic features each representing the receiving devices A, B, C in the order of B, A, C. In some embodiments, the users' names or device names can be displayed concurrently with the graphic features. This may make sharing content with a particular user(s) easy and seamless (e.g., in some embodiments where the sharing user can share data individually to certain devices).

As discussed above, in response to detecting a user input, one or more receiving devices can be detected by system 100. Once the receiving devices are detected (and shown on a user interface feature as graphic features in some embodiments), the user may perform a user action that signifies intent to transmit or share data to the one or more detected receiving devices. As discussed above, there may be a variety of different user actions that inform the system 100 that the user wants to share data. The user action may include button presses on keys/buttons, or taps/gestures on a user interface feature or soft button or icon on a touch screen display of the computing device. The user action may also be a tap, drag and release of a user interface feature, like a sling shot metaphor, or be a movement of the computing device itself by the user, e.g., a shake or a frisbee throwing motion. The user action may be a combination of both a user input on a touch screen display as well as a concurrent movement of the computing device.

In one embodiment, action interpreter 120 also detects user action signifying intent to transmit content to the detected devices and communicates action information 127 to content manager 110. Content manager 110 also receives device information 135 corresponding to the detected receiving devices from device detect/select component 130. In some embodiments, the user action signifying intent to transmit data can be the same user action or input for detecting the receiving device(s) discussed above. For example, when a user performs a “sling shot” gesture (e.g., hold and drag down a user interface feature corresponding to data to be sent, and then releasing the user interface feature), the user action can cause the device detect/select component 130 to detect the receiving devices and cause content manager 110 to identify content that is to be transmitted. In other embodiments, there may be a first user action/input and a second user action/input to initiate device detection and transmit data, respectively.

Content manager 110 can identify or determine data that is in a state designated to be transmitted based on the action information 127 and UI component 112. In some embodiments, a user may view or access multiple applications and/or content on a computing device at the same time. For example, the user may have a music player running that is playing a song, may have a web browser application open, and may also be looking at photos stored in a memory of the computing device. When the user wants to share a photograph with one or more other devices, content manager 110 determines which the data should be transmitted, so that the photograph is shared instead of the song, a web page (or link) or any application.

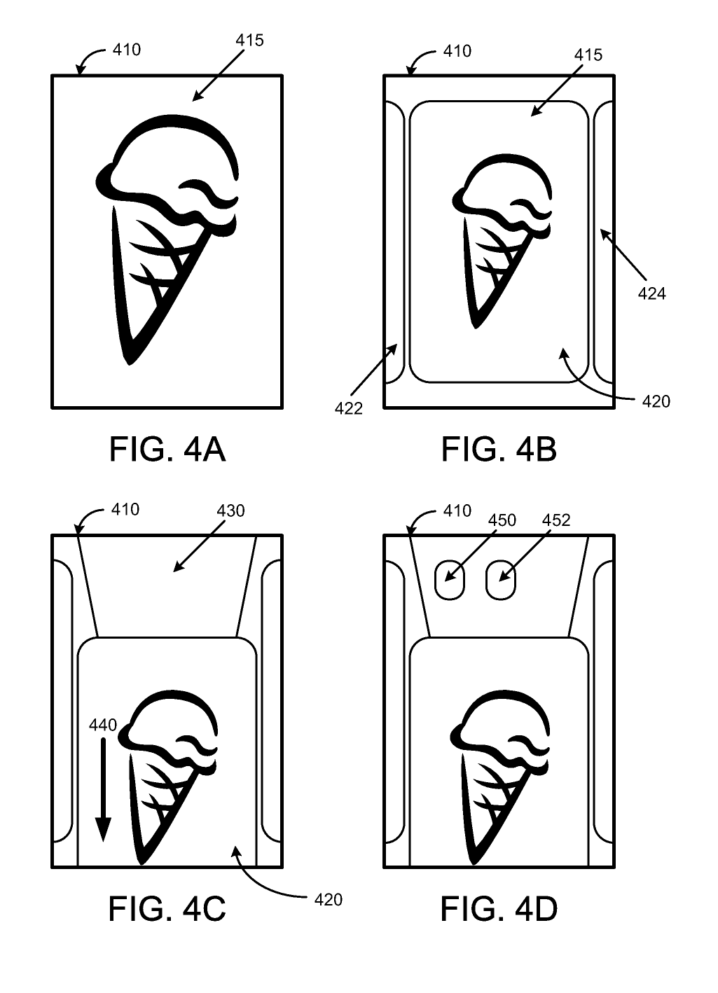

According to one or more embodiments, the data that the user wants to share or transmit may be focused or designated on the display of the computing device in a particular manner that is different than other data that is not to be shared. For example, in the webOS operating system, card metaphors are used to depict applications and/or content that are currently running and/or currently being viewed by a user. A card or user interface feature that is currently being accessed by a user is typically shown in the middle or center of the display and/or covers a majority of the display. In one embodiment, depending on what content (e.g., shown on a card) is currently in this middle or majority position, content manager 110 (operating in conjunction with UI component 112) can programmatically identify which data or content is in a state designated to be shared or transmitted from the computing device. Other programmatic methods can be used in different operating system scenarios based on how the user operates content that he or she wishes to share or transmit. Examples of the user interface feature for explanatory purposes are illustrated below with respect to FIG. 4. In other embodiments, content manager 110 can send multiple content shown on multiple user interface features that are concurrently opened and/or being accessed by the user.

According to one or more embodiments, content manager 110 retrieves application and/or content information 155 (e.g., data) from application/content database 140. Content manager 110 can retrieve the proper data corresponding to the identified content from application/content database 140 to transmit to one or more receiving devices. After identifying the data to be transmitted, content data 115 is communicated to the wireless communication component 150 so that content data 159 can be transmitted wirelessly to the one or more receiving devices. Because content manager 110 receives device information 135 about the receiving devices, the wireless communication component 150 can enable the proper devices to receive content data 159 using a wireless connection. In some embodiments, in response to detecting the user action (e.g., the user action corresponding to the user intent to transmit or share data, such as a sling shot action on the user interface feature or a flicking of the computing device itself), a wireless connection is automatically established between the computing device and the one or more detected receiving devices. Content data 159 can be transmitted to the one or more detected receiving devices via the established wireless connection.

In some embodiments, the wireless connection uses Bluetooth protocol communication, Wi-Fi protocol communication, infrared communication, or visible light communication to connect between devices. Using this wireless connection, peer-to-peer data transfer can be performed between the source device (e.g., computing device) and one or more detected receiving devices.

In another embodiment, data can be shared or transmitted to one or more receiving devices using a network so that data is not transferred directly from a source device to a receiving device. Content data 159 that is transmitted to the one or more receiving devices can be a pointer, for example, to information that is stored in a network (e.g., a cloud) and that corresponds to the content the user is attempting or wants to share. The one or more receiving devices can receive the pointer via the wireless connection, and using the pointer, automatically retrieve the information that the pointer points to in order to automatically launch or display content on the receiving device. This may be beneficial when data is stored on remote servers on networks and not stored in a memory of the source device. In other embodiments, data that corresponds to a website, such as a URL, can be transmitted to one or more receiving devices as content data 159 so that the receiving device can automatically open or launch the website using the URL on a browser application. By transmitting metadata or pointers, for example, bandwidth usage and time of data transmission may be reduced for sharing data between devices.

According to an embodiment, data is transmitted from a source device to multiple receiving devices concurrently. For example, when a user wants to share a word processing document to three other users, by performing one user action to transmit the data, all three users (assuming that they each have a receiving device that is in a mode to receive data) may receive the word processing document all at the same time. However, in another embodiment, the user may transmit or share data to only certain users (e.g., to only one user even though three users are ready to receive) by performing a user action directed to that one user. This may be done, in some embodiments, by performing the user action in the direction of the particular receiving user and her device (e.g., by making a frisbee throwing motion to only that user) or by performing a user action on a particular graphic feature of the user's device on the radar field. This is possible through the user of relative and/or absolute positioning information as discussed above (e.g., the source device recognizes the position and location of the receiving devices within a vicinity).

In another embodiment, a user may transmit data with an individual receiving device by pointing or motioning her source device to the particular user (and user's receiving device). Using sensors and triangulation methods discussed above, when the sharing user points her device in the direction of a particular receiving device, only that device shows up as a graphic feature on the source device's display. In this manner, identified data to be shared can be individually transmitted to that particular user.

In some embodiments, once the wireless connection is made between the source device and the one or more receiving devices, the sharing user may share or transmit other data with any of the one or more receiving devices. For example, the user may navigate between applications and/or content by interacting with the user interface features to transmit different content to the one or more receiving devices individually or concurrently. The additional application or content can be centered in the middle of the display, for example, which signifies the new content the user wants to share.

According to an embodiment, a sharing user may share data with one or more receiving devices that do not have the same applications stored in the memory. For example, if a user shares data that corresponds to a particular game and the receiving user device does not have the game installed or stored in the device, the receiving user may receive a prompt that notifies the receiving user that the game or application needs to be downloaded. The notification can provide a link or graphic feature that the receiving user may select to be automatically navigated to an application catalog, for example. The receiving user may also reject the data based on rejecting the downloading of the application necessary to view or access the received data.

Methodology

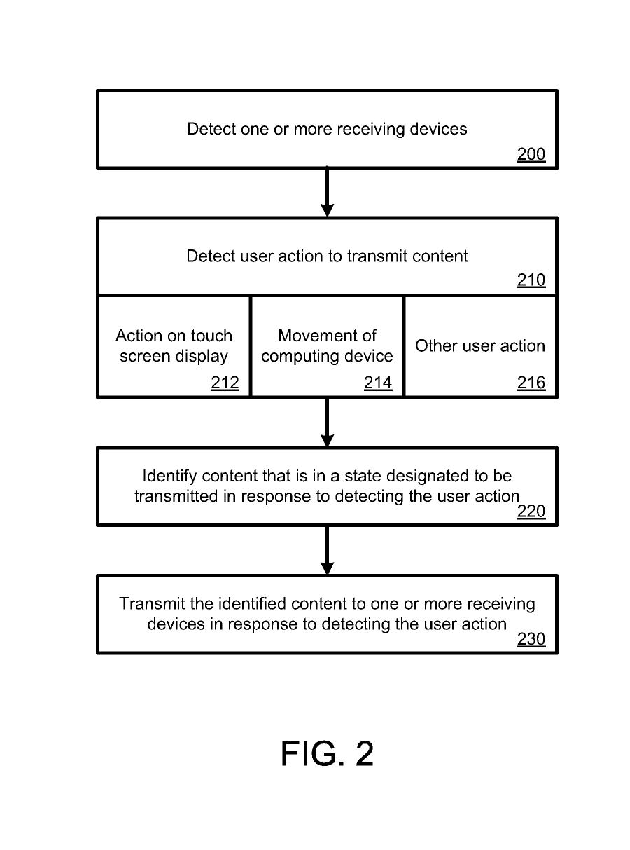

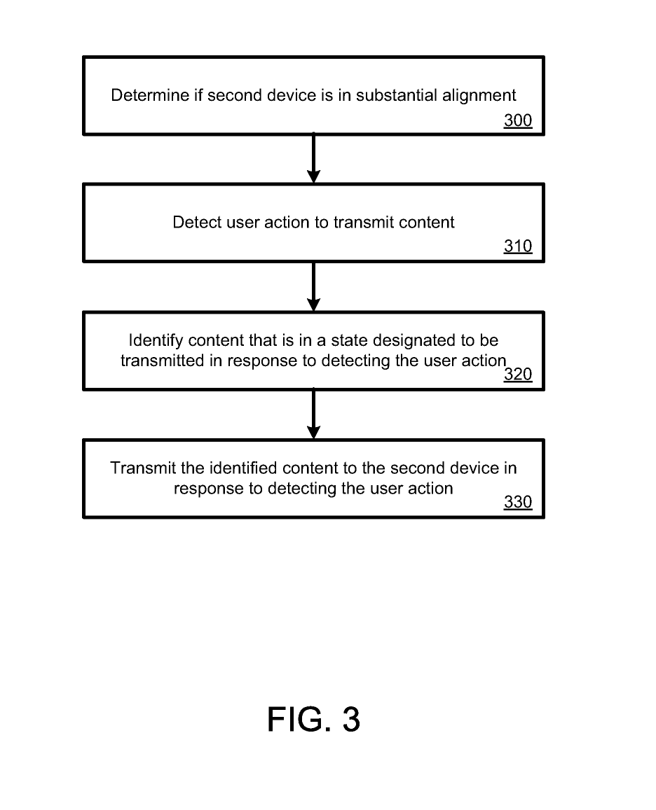

Methods such as described by an embodiment of FIGS. 2 and 3 can be implemented using, for example, components described with an embodiment of FIG. 1. Accordingly, references made to elements of FIG. 1 are for purposes of illustrating a suitable element or component for performing a step or sub-step being described. FIG. 2 illustrates a method for wirelessly sharing data amongst devices in response to a user action, according to an embodiment.

In FIG. 2, the computing device (e.g., the source device) detects one or more receiving devices within its vicinity or a predetermined proximity (step 200). A user of the source device may cause the computing device to perform device detection in response to a user action or input on the computing device. For example, when a user wants to share data he or she is currently viewing or accessing, the user may place a user interface feature that corresponds to the data in a different state than a state it was in previously, and perform an action on the user interface feature. Action interpreter 120 determines the user action and triggers device detect/select component 130 (via action information 127) to communicate with the wireless communication component 150 to detect devices in the vicinity of the computing device. Devices that are in a mode or operated in a mode to receive data is detected and a visualization of the detected receiving devices can be displayed on the computing device.

The computing device detects a user action signifying intent of the user to transmit data to the detected receiving devices (step 210). In some embodiments, this user action can be a separate user action than the action to detect the devices (in step 200) or can be a part of the same user action (e.g., continued action). Action interpreter 120 detects the user action in response to receiving information from one or more sensors of the computing device (e.g., accelerometers, gravitometers, magnetometers) and/or one or more user input mechanisms (e.g., buttons, keys, keyboard, touch screen display). In one embodiment, the user action can be an input on a touch screen display (step 212). The input can be a tap, multiple tap or tap and drag on a user interface feature on the touch screen display, or can be a gesture such as a drag and drop, or a quick swipe. As an addition or alternative, the user action can be a movement of the computing device (step 214), such as a shake or frisbee-throw motion. Other user actions (step 216) are possible, such as the combination of both touch screen input and motion of the computing device, or voice activation by speaking into a microphone, or inputs through physical buttons or keys.

In response to detecting the user action, the computing device identifies data that is in a state designated to be transmitted (step 220). Content manager 110 receives action information 127 from action interpreter 120, and determines what data the user has designated to share with other devices. In some embodiments, the data can be in a state designated to be transmitted in response to the user action on a particular content. For example, the user may perform an action on the user interface feature of the particular content he or she is attempting to share, and content manager 110 can programmatically determine what the data is based on the user input and the user interface feature. If the user wants to share a particular document, for example, the user may perform a sling shot action on the user interface corresponding to the document (e.g., tap, hold and drag down). This user action may cause the computing device to detect one or more receiving devices and also identify what data the user wants to share at the same time.

The identified content can then be transmitted to the detected receiving device(s) in response to detecting the user action (step 230). Content manager 110 communicates with application/content database 140 to receive data 155 corresponding to the identified content to be transmitted and sends content data 115 to the wireless communication component 150 for wireless transmission. In some embodiments, in response to detecting the user action, a wireless connection is automatically established between the computing device and the receiving device(s). In other embodiments, the wireless connection can be established before detecting the user action, such as after the computing device detects the receiving devices that are operated in a mode to receive data. Using the wireless connection (e.g., Bluetooth protocol communication, Wi-Fi protocol communication, infrared communication, visible light communication), the content data 159 from the wireless communication component 150 can be transmitted to the one or more receiving devices (that are in a mode to receive data).

In some embodiments, after the wireless connection is established between the computing device and one or more receiving devices, the user may share additional data with the one or more receiving devices. The user may navigate through the user interfaces to open or launch additional applications or view additional data, and share additional data using similar methods described (e.g., through user action such as a frisbee-throwing motion). The method described enables efficient and seamless content sharing between devices to be possible.

FIG. 3 illustrates a method for wirelessly sharing data from a computing device to other devices in response to a user action, under another embodiment. FIG. 3 may be an addition or may be part of the method as described with FIG. 2. A user of a computing device may want to share data with one device instead of multiple devices. In FIG. 3, the computing device determines if a second device (e.g., a receiving device) is in substantial alignment with the computing device (step 300). In other embodiments, similar methods may be used to detect a receiving device (as described with FIGS. 1 and 2). In one embodiment, determining whether the second device in substantial alignment with the computing device is one way to determine if the receiving user wants to receive data from the source device.

Two devices may be determined to be substantially aligned by using one or more sensors on one or more devices. In the context of “substantial alignment”, or variations thereof, two devices are substantially aligned if they are directionally oriented towards one another sufficiently to enable one device to select the other device apart from one or more other devices that are proximate (or equally proximate) to the selected device or substantially equally spaced from the selecting device. For example, sensors can be located near lateral sides of the computing device and/or the receiving device so that when the devices are laying down flat on a surface (e.g., back face on the surface of a table), the sensors on one or more lateral sides (e.g., such as a proximity sensor) can determine if the devices are near or adjacent to each other.

In some embodiments, the source device and the receiving device can be positioned head-to-head, so that the lateral side of the top of one device is substantially aligned with the lateral side of the other device. Other variations are possible, such as head-to-side or side-to-side or bottom-to-bottom, etc., in order to determine substantial alignment. In some embodiments, there can be an alignment threshold to determine if substantial alignment has been met. The alignment threshold can be a predetermined value or parameter that is used to determine if two devices are aligned so that a set of lateral sides of one device is substantially aligned with a set of lateral sides of the other device.

After aligning the devices, the computing device detects a user action signifying intent of the user to transmit data with the second device (step 310). Similar to the steps described in FIG. 2, a variety of different user actions can be detected. In one embodiment, the user action can be a tap, drag and release (e.g., like a sling shot) of a user interface feature representing the data the user wants to share on a touch screen display of the computing device. In another embodiment, the user action can be a swiping gesture.

In response to detecting the user action, the computing device identifies data that is in a state designated to be transmitted (step 320). As discussed above with respect to FIG. 2, the data to be transmitted can be in a different state than other data that is not to be transmitted. For example, the user may perform the above-described user action on the user interface feature of the particular content (e.g., a photograph) she wants to share with the second device, and content manager 110 can programmatically determine what that content is based on the user input on the user interface feature (and state the content is in).

The identified data is transmitted to the second device (step 330). Content manager 110 communicates with application/content database 140 to receive data 155 corresponding to the identified data to be transmitted and sends content data 115 to the wireless communication component 150 for wireless transmission. According to an embodiment, in response to detecting the user action, a wireless connection is automatically established between the computing device and the second device. In other embodiments, the wireless connection can be established before detecting the user action, such as in response to the computing device detecting that the second device is substantially aligned with the computing device. Using the wireless connection, the data can be transmitted to the second device in a peer-to-peer fashion or using pointers to a cloud network (as discussed previously).

Exemplary User Interface

FIGS. 4A-4D illustrate a plurality of user interface features on a computing device for sharing data amongst devices, according to an embodiment. The exemplary user interface illustrations of FIGS. 4A-4D can represent what a sharing user can see on his or her computing device when using the system described in FIG. 1 and methods described in FIGS. 2 and 3. FIG. 4A illustrates a touch screen display 410 of the computing device (e.g., source device). The user is currently viewing a photograph 415. In FIG. 4B, the user alters the state of the user interface feature of the photograph viewing application and/or the photograph 415 itself so that the photograph 415 is not longer in a full view, but is shown in a different view. In one example, the view is a card 420 of the photograph 415 or the photograph viewing application. In FIG. 4B, two other cards corresponding to other content and/or applications 422, 424 are also shown. The focus is not on the cards 422, 424 but is on the card 420 showing the photograph 415.

The user wants to share the photograph 415 with other users. In FIG. 4C, the user performs a user action on the card 420 (the user interface feature representing the content the user wishes to share) so that a radar field 430 (or some other user interface is shown on the display 410) is shown. The user action may be a hold and drag down of the user interface feature (e.g., card 420) in the direction 440. By performing an input on the user interface feature corresponding to the photograph 415 that the user wants to send, device detection is performed by the computing device.

In FIG. 4D, a visualization of the detected receiving devices that are operated in a mode to receive the photograph 415 is shown in the radar field. Device 450 and device 452 are illustrated as a graphic feature on the display 410 of the device so that the user knows who is ready to accept the photograph 415. In some embodiments, the user may simply let go of the card 420 (e.g., the user first held and dragged down, and the user can let go, so that the card flings upwards to its original position as shown in FIG. 4B), and this would be a user action that is detected by the computing device as the user action signifying intent of the user to share content. In other embodiments, the user may perform another action, such as holding the card 420 with a finger and moving the computing device in a frisbee-throwing motion.

In some embodiments, once the device detection and wireless connection has been performed, the user may share additional data (e.g., data corresponding to additional content) with one or more receiving devices easily. For example, the user may want to share data corresponding to the user interface feature 422 (see FIG. 4B). The user may navigate by placing card 422 in focus (e.g., in the middle of the display 410) instead of card 420, and perform a user action on the card 422 to share the content with devices 450, 452. In other embodiments, the user may share data individually to certain detected receiving devices through user actions pertaining to the particular graphic feature displayed in the radar field 430. For example, the user may hold and drag any of the cards 420, 422, 424 to the particular graphic feature 452 to share a particular content to only that user with the receiving device corresponding to feature 452. If any of the devices either changes mode to not receive data or leaves the vicinity of the source device, the radar field 430 will show a change in the graphic features shown.

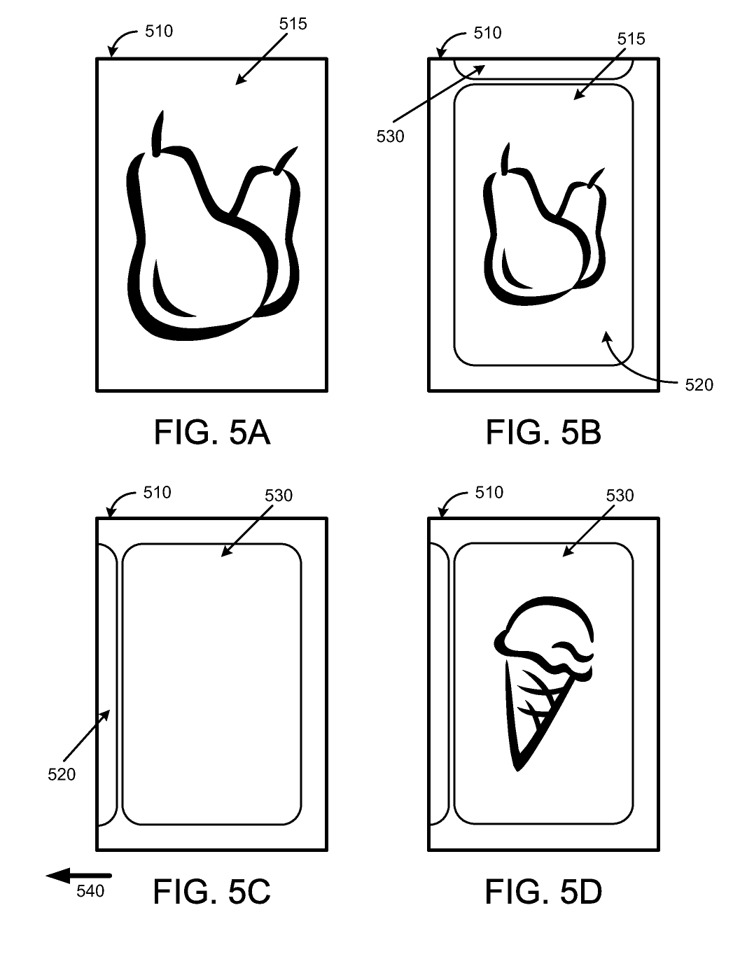

FIGS. 5A-5D illustrate a plurality of user interface features on a receiving device for receiving data from a source device, according to one or more embodiments. The exemplary user interface illustrations of FIGS. 5A-5D may represent what a receiving user may see on his or her computing device when receiving data from a source device. In FIG. 5A, the receiving user is accessing an application or viewing content 515 on her computing device. The application or content 515 is provided as a full screen interface on the display 510.

In one embodiment, the user of the receiving device has already performed some action so that she is able to receive data from other devices or specifically from the particular sharing user's device (e.g., her device is operated in a mode to receive content). When the user's receiving device receives data, in FIG. 5B, the device automatically changes the state of the currently viewing application or content so that it is different than before (e.g., change to a card 520 view from a full screen view in FIG. 5A). Notification of the shared content (e.g., received data) is seen on the receiving device. In one embodiment, the notification is as a lighter view (e.g., more transparent) of another card 530. In other embodiments, the receiving user may receive a prompt or alert notifying the user that data is being received and whether the receiving user wants to accept and/or fully download the data.

In FIG. 5C, when the user accepts the data (or after a predetermined time or instantaneously after receiving a notification in some embodiments), the shared content is displayed, using the received data, on the display 510 as a card 530. This may be a transparent card compared to a normal user interface card on the display 510. The previously viewed application or content 520 is automatically moved over to the left (or the right) in the direction 540 so the received content is automatically put into focus. In other embodiments, the previously viewed application or content 520 can still remain in focus (e.g., in the middle, focused on the display 510) and the shared received content 530 can be moved over to the side so it is partially hidden. In some embodiments, once the data is fully received and/or downloaded, the receiving user may automatically view the shared content 530 on the display in FIG. 5D. In this example, the photograph is not viewable until data for the photograph is fully received.

Usage Examples

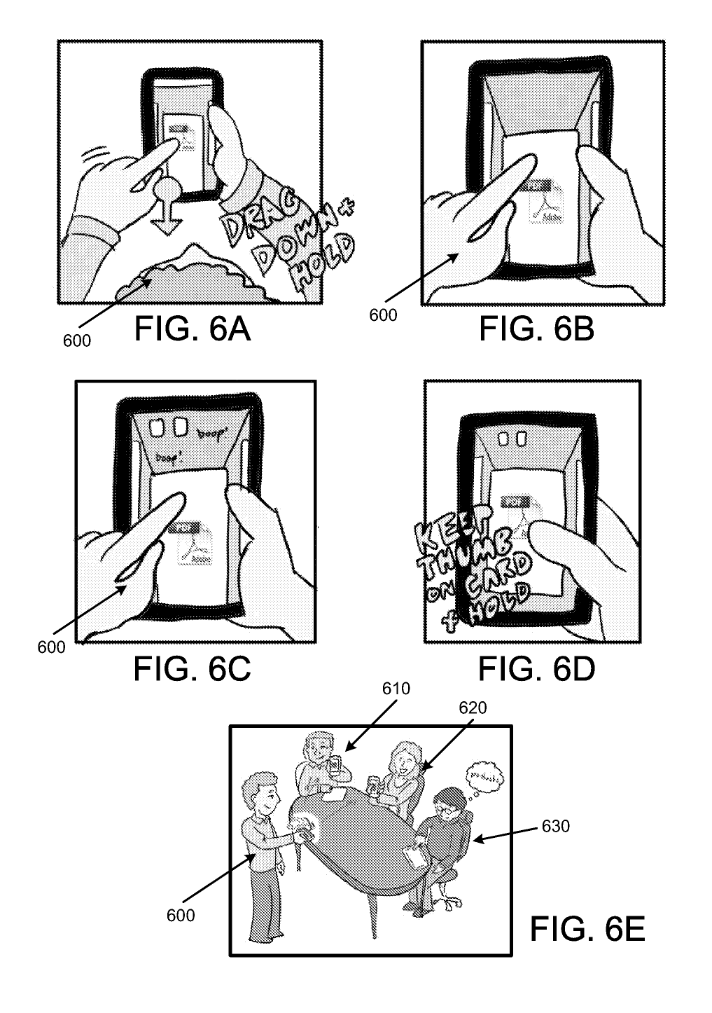

FIGS. 6A-6E illustrate a usage scenario for sharing data with a plurality of devices, under an embodiment. The usage scenario of FIGS. 6A-6E may be performed by the system and methods described in FIGS. 1-3. In FIG. 6A, the sharing user 600 wishes to share a document (e.g., a PDF file). The sharing user 600 performs a user action on the document that is in a state designated to be transmitted. In this example, the document is made smaller than the full screen size, but is still in focus in the middle of the display. In one embodiment, the user performs a “drag down and hold” action.

In response to the user action, a radar field or user interface feature appears on the display (see FIG. 6B). In FIG. 6C, the computing device detects devices in its vicinity that are operated in a mode to receive data from sharing user 600. Indication of these devices is shown in the radar field as graphic features. In FIG. 6D, the user prepares to transmit the data by keeping a thumb down on the card (e.g., the user interface corresponding to the document the user wants to share). The user then performs an action (e.g., a frisbee-throwing motion or shaking of the computing device) so that the receiving user 610 and receiving user 620 receives the data on their devices. User 630 does not have his device in a mode to receive data so this user's device does not show up on the radar field (in FIG. 6C or FIG. 6D), and the user 630 does not receive the data on his device. In one embodiment, the users 610, 620 are holding their devices up so the screen faces the device of the sharing user 610. This is a way to indicate to the sharing user 610 that the devices of users 610, 620 are operated in a mode to receive data.

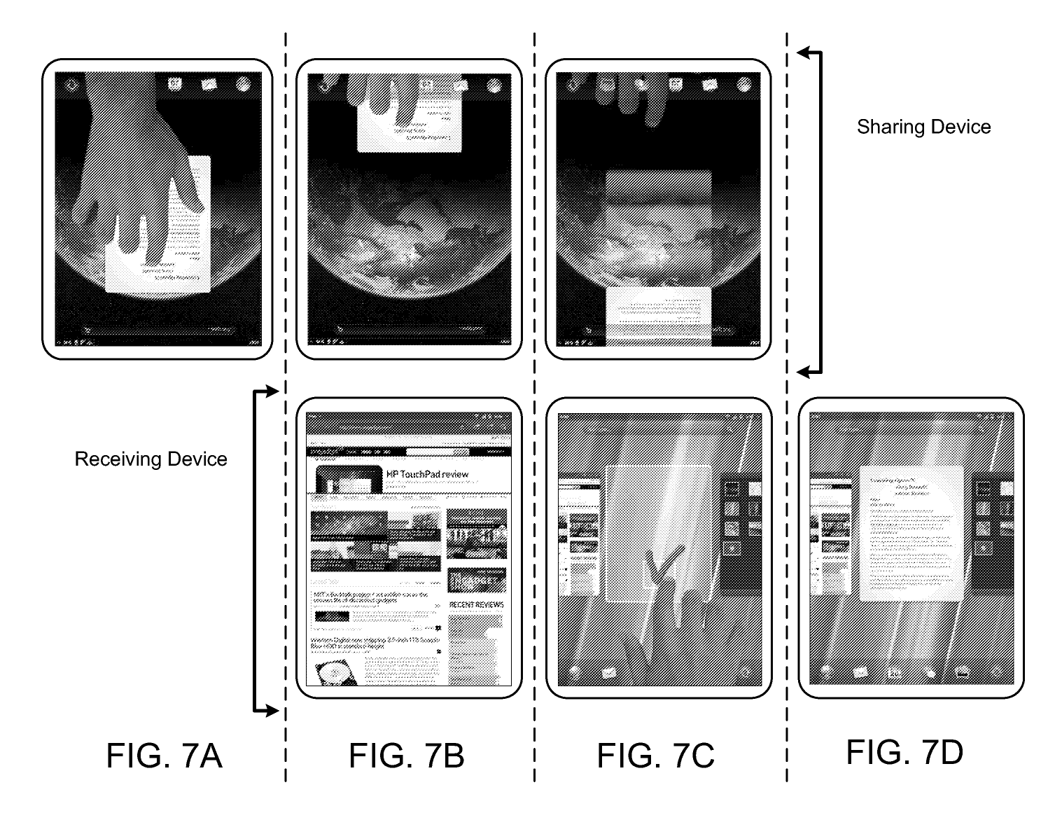

FIGS. 7A-7D illustrate a usage scenario for sharing data with a plurality of devices, under another embodiment. The usage scenario of FIGS. 7A-7D can be performed by the system and methods described in FIGS. 1-3. In one embodiment, FIGS. 7A-7D can be performed between two users who are sitting across from each other or next to each other, for example, and substantially align the devices with one another in a head-to-head configuration.

In FIG. 7A, the user has a document that he wants to share from the source device. This document is focused in the center of the display, but is in a state that is designated to be transmitted (e.g., different than viewing the document in a full page screen). In FIG. 7B, the source device and the receiving device are substantially aligned with each other in a head-to-head configuration. The sharing user performs a user action on the content he wants to share. At this time, the receiving user is currently viewing content or operating another application (e.g., a website on a browser application). In FIG. 7C, the sharing user performs an action (or finishes performing an action that he started performing in FIG. 7B) that signifies intent to transmit data to the receiving device. The user interface of the source device provides an indication to the sharing user that data has been transmitted (or attempted to be transmitted) to the receiving device. The receiving device receives the data (or partially receives data) and provides a notification to the receiving user (e.g., in the form of a phantom card) that data has been received. In one embodiment, the receiving user can be prompted to accept or reject the received data before that the data can be displayed on the receiving device. In FIG. 7C, the user is prompted to check a box in order to accept the data from the source device.

In FIG. 7D, after the user has accepted to receive content, data can be fully downloaded via peer-to-peer transmission or via a cloud network using pointers. The shared content will be displayed on the receiving device using the received data.

Hardware Diagram

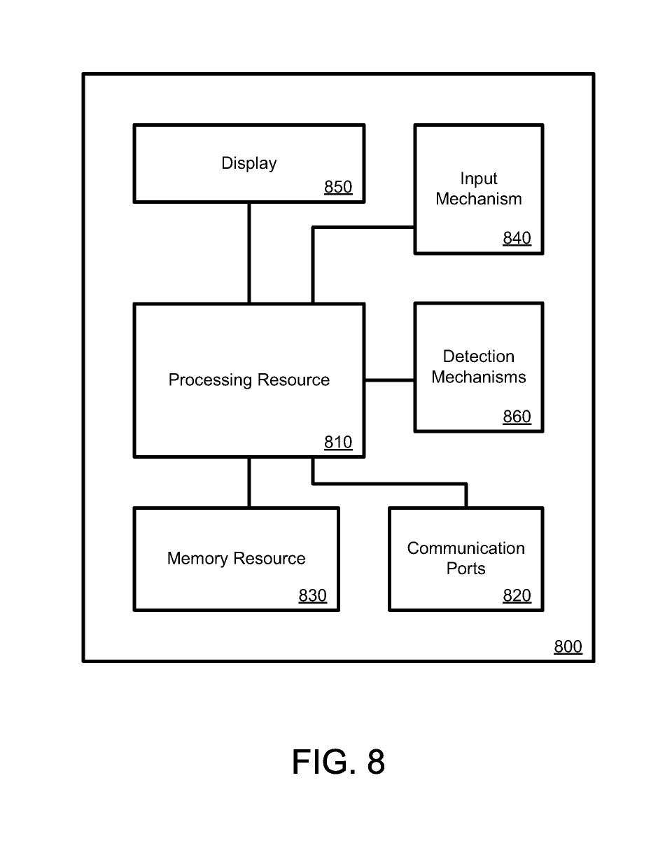

FIG. 8 illustrates a hardware diagram of a computing device for wirelessly data content with other devices in response to a user action, according to one or more embodiments. For example, in the context of FIG. 1, system 100 can be implemented using a computer system such as described by FIG. 8.

In an embodiment, computing device 800 includes a processing resource 810, communication ports 820, memory resource 830, input mechanism 840, display 850 and detection mechanisms 860. The processing resource 810 is coupled to the memory resource 830 in order to process information stored in the memory resource 830, perform tasks and functions, and run programs for operating the computing device 800. The memory resource 830 can include a dynamic storage device, such as random access memory (RAM), and/or include read only memory (ROM), and/or include other memory such as a hard drive (magnetic disk or optical disk). Memory resource 830 can store temporary variables or other intermediate information during execution of instructions (and programs or applications) to be executed by the processing resource 810.

In some embodiments, the processing resource 810 is also coupled to various detection mechanisms 860, such as accelerometers, gravitometers, magnetometers, proximity sensors and location aware resources, such as global positioning services (GPS). Using data provided by the detection mechanisms 860, the processing resource 810 can detect movements of the computing device made by a user (e.g., shake, frisbee-throwing motion). Detection mechanisms 860 can also include emitters and/or receptors for device location and positioning detection purposes, e.g., for triangulation purposes as discussed above.

The computing device 800 can include a display 850, such as a cathode ray tube (CRT), a LCD monitor, an LED screen, a touch screen display, a projector, etc., for displaying information and/or user interfaces to a user. Input mechanism 840, including alphanumeric keyboards and other buttons (e.g., volume buttons, power buttons, and buttons for configuring settings), is coupled to computing device 800 for communicating information and command selections to the processing resource 810. In some embodiments, some of the input mechanisms 840 can be incorporated as part of the touch screen display 850. Other non-limiting, illustrative examples of input mechanism 840 include a mouse, a trackball, a touchpad, a touch screen display, or cursor direction keys for communicating direction information and command selections to the processing resource 810 and for controlling cursor movement on display 850. Embodiments can include any number of input mechanisms 840 coupled to computing device 800.

Computing device 800 also includes communication ports 820 for communicating with other devices and/or networks (both wirelessly and through use of a wire). Communication ports 820 can include wireless communication ports for enabling wireless network connectivity with a wireless router, for example, or for cellular telephony capabilities (e.g., when the computing device 800 is a cellular phone or tablet device with cellular capabilities). Communication ports 860 can also include IR, RF or Bluetooth communication capabilities, and can enable communication via different protocols (e.g., connectivity with other devices through use of the Wi-Fi protocol (e.g., IEEE 802.11(b) or (g) standards), Bluetooth protocol, etc.).

Embodiments described herein are related to the use of the computing device 800 for implementing the techniques described herein. According to one embodiment, the techniques are performed by the computing device 800 in response to the processing resource 810 executing one or more sequences of one or more instructions contained in the memory resource 830. Such instructions can be read into memory resource 830 from another machine-readable medium, such as an external hard drive or USB storage device. Execution of the sequences of instructions contained in memory resource 830 causes the processing resource 810 to perform the process steps described herein. In alternative embodiments, hard-wired circuitry can be used in place of or in combination with software instructions to implement embodiments described herein. Thus, embodiments described are not limited to any specific combination of hardware circuitry and software.

It is contemplated for embodiments described herein to extend to individual elements and concepts described herein, independently of other concepts, ideas or systems, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for wirelessly sharing data, the method being performed by one or more processors of a computing device and comprising:
detecting one or more receiving devices that are operated in a mode to receive data from the computing device;
detecting a user action signifying intent of a user to transmit data to the one or more receiving devices;
in response to detecting the user action, identifying data that is in a state designated to be transmitted; and
transmitting the identified data to the one or more receiving devices, wherein transmitting the identified data includes automatically establishing a wireless connection between the computing device and the one or more receiving devices in response to detecting the user action.

2. The method of claim 1, wherein detecting one or more receiving devices includes detecting one or more receiving devices within a predetermined proximity of the computing device in response to receiving a user input.

3. The method of claim 1, wherein detecting the one or more receiving devices includes presenting, on a display of the computing device, one or more graphic features that each represents the one or more receiving devices, the one or more graphic features being displayed in a manner relative to locations of the one or more receiving devices relative to the computing device.

4. The method of claim 1, wherein the computing device includes a touch screen display, and wherein the user action includes at least one of: (i) a tap, drag and release of a user interface feature that represents the identified data on the touch screen display of the computing device, (ii) a swiping gesture on the user interface feature that represents the identified data on the touch screen display, (iii) a movement of the computing device, or (iv) a tap and hold on the user interface feature that represents the identified data on the touch screen display, and a concurrent movement of the computing device.

5. The method of claim 1, wherein the identified data includes data corresponding to at least one of an application, a document, a website link, contact information, a calendar entry, an email, a text message, music, images, or videos.

6. The method of claim 1, wherein the wireless connection uses at least one of Bluetooth protocol communication, Wi-Fi protocol communication, infrared communication or visible light communication.

7. The method of claim 1, wherein transmitting the identified data includes (i) transmitting a pointer to information stored in a network, and (ii) enabling the one or more receiving devices to automatically launch or display content corresponding to the identified data in response to retrieving the information from the network by using the pointer.

8. The method of claim 1, further comprising:
enabling the user to select a second data to be transmitted;
detecting a second user action;
in response to detecting the second user action, identifying the second data that is in a state designated to be transmitted; and
transmitting the identified second data to the one or more receiving devices.

9. A system for sharing data between devices, the system comprising:
a source device configured to:
detect one or more receiving devices that are operated in a mode to receive data from the source device;
detect a user action on the source device signifying intent of a user to transmit data to the one or more receiving devices;
in response to detecting the user action, identify data that is in a state designated to be transmitted; and
transmit the identified data to the one or more receiving devices, wherein transmitting the identified data includes automatically establishing a wireless connection between the source device and the one or more receiving devices in response to detecting the user action.

10. The system of claim 9, wherein the source device is configured to detect the one or more receiving devices by detecting one or more receiving devices within a predetermined proximity of the computing device in response to receiving a user input.

11. The system of claim 9, wherein the one or more receiving devices is configured to operate in the mode in response to one or more receiving users performing at least one of: (i) positioning the one or more receiving devices in an upright position, (ii) positioning the one or more receiving devices so that a front face of the one or more receiving devices is facing the source device, (iii) moving the one or more receiving devices in a flick motion, or (iv) shaking the one or more receiving devices.

12. The system of claim 9, wherein the source device is further configured to present, on a display of the source device, one or more graphic features that each represents the one or more receiving devices, the one or more graphic features being displayed in a manner relative to locations of the one or more receiving devices relative to the source device.

13. The system of claim 9, wherein source device includes a touch screen display, and wherein the user action includes at least one of: (i) a tap, drag and release of a user interface feature that represents the identified data on the touch screen display of the source device, (ii) a swiping gesture on the user interface feature that represents the identified data on the touch screen display, (iii) a movement of the source device, or (iv) a tap and hold on the user interface feature that represents the identified data on the touch screen display and a concurrent movement of the source device.

13. The system of claim 9, wherein the identified data includes data corresponding to at least one of an application, a document, a website link, contact information, a calendar entry, an email, a text message, music, images, or videos.

15. The system of claim 9, wherein the wireless connection uses at least one of Bluetooth protocol communication, Wi-Fi protocol communication, infrared communication or visible light communication.

16. The system of claim 9, wherein the source device is configured to transmit the identified data by transmitting a pointer to information stored in a network, and wherein receiving the identified data includes automatically launching or displaying content corresponding to the identified data in response to retrieving the information from the network by using the pointer.

17. The system of claim 9, wherein the one or more receiving devices is configured to (i) notify a receiving user of the identified data that the identified data has been receiving from the source device, and (ii) launch or display content corresponding to the identified data in response to receiving a user input that corresponds to the receiving user accepting the identified data.

18. A method for wirelessly sharing data, the method being performed by one or more processors of a computing device and comprising:
making a determination whether a second device is in substantial alignment with the computing device;
detecting a user action signifying intent of a user to transmit data to the second device;
in response to detecting the user action, identifying data that is in a state designated to be transmitted; and
transmitting the identified data to the second device, wherein transmitting the identified data includes automatically establishing a wireless connection between the computing device and the second device in response to detecting the user action.

19. The method of claim 18, wherein the computing device includes a touch screen display, and wherein the user action includes at least one of: (i) a tap, drag and release of a user interface feature that represents the identified data on the touch screen display of the computing device, or (ii) a swiping gesture on the user interface feature that represents the identified data on the touch screen display.

20. The method of claim 18, wherein transmitting the identified data includes transmitting a pointer to information stored in a network and enabling the second device to automatically launch or display content corresponding to the identified data in response to retrieving the information from the network by using the pointer.
